(19) United States
(12) Patent Application Publication
(10) Pub. No.: US 2004/0073440 A1
(43) Pub. Date: Apr. 15, 2004

(54) System for vehicle assignment and pickup

(76) Inventors: Jeffrey Garbers, Roswell, GA (US); William Vestal, Avondale Estates, GA (US)

Correspondence Address: TROUTMAN SANDERS LLP, BANK OF AMERICA PLAZA, SUITE 5200, 600 PEACHTREE STREET , NE, ATLANTA, GA, 30308-2216, US

(21) Appl. No.: 10/426,055

(22) Filed: Apr. 28, 2003

Related U.S. Application Data
(60) Provisional application No. 60/377,106, filed on Apr. 26, 2002.

(51) Int. Cl. G06F 17/60

(52) U.S. Cl. 705/1; 705/5

(57) ABSTRACT

A system, including apparatuses and methods, for managing vehicle reservations, vehicle assignment, and vehicle access. The system enables a rental vehicle or car sharing agency (i.e., or for that matter, a vehicle fleet management service or other similar entity) to assign vehicles to users of the vehicles in accordance with previously received reservations vehicle information, and other information, and enables the users to pickup the vehicles for their use, without interaction with agency personnel.

### CROSS REFERENCE TO RELATED APPLICATION

This application claims the benefit of priority to U.S. provisional application Serial No. 60/377,106 entitled “System for Vehicle Assignment and Pickup” filed on Apr. 26, 2002 (pending).

### FIELD OF THE INVENTION

The present invention relates, generally, to the field of vehicle fleet management and, in its preferred form, to the field of apparatus and methods for assigning vehicles to users and enabling the pickup of assigned vehicles by users.

### BACKGROUND OF THE INVENTION

For many years, customers of vehicle rental agencies have reserved vehicles for their use through telephone conversations, or dialogues, with customer service representatives. Today, those customers may still reserve vehicles in the same manner or may utilize more modern methods, including the use of interactive voice response systems or the Internet. Regardless of the method employed to reserve a vehicle, the customer, generally, specifies a desired type of vehicle and the period of time during which the customer requires use of the vehicle. The specified type of vehicle and period of time form a part of the reservation.

Unfortunately, technology has not substantially found its way into the processes of assigning or picking up a reserved vehicle. As a consequence, the pickup of a reserved vehicle by a customer still requires that the customer interact with an agent of a vehicle rental agency. Initially, the agent must confirm that the customer has a valid reservation and that the agency has a vehicle of the type identified in the reservation available for assignment to the customer. Once the agent confirms these things, the agent selects an available vehicle (i.e., if more than one vehicle is available for assignment) and assigns the selected vehicle to the customer (e.g., by the input of customer and vehicle information to a computer system). The agent then provides the customer with conventional toothed metal keys unique to the vehicle (i.e., the toothed metal keys work only with one vehicle), information which identifies the current location of the vehicle (e.g., a number assigned to the parking space in which the vehicle was placed by other vehicle rental agency personnel), and instructions directing the customer on how to find the vehicle's location. The customer then makes his/her way to the vehicle, inserts the appropriate key into one of the vehicle's door locks and unlocks the door lock, opens the corresponding door, enters the vehicle and drives away.

Thus, the current methods of assigning and picking up a reserved vehicle rely heavily on agents to assign vehicles and provide their keys to customers, and on a staff of vehicle rental agency personnel to place available vehicles in numbered parking spots (i.e., after return of the vehicles by other customers) and to provide the numbers of the parking spots to the agents for subsequent assignment of the corresponding vehicles. As a result, the current methods do not readily lend themselves to self-service vehicle rental or sharing operations where no agents are present to assign vehicles and hand out keys, and where customers return their vehicles to parking spots selected entirely at their own discretion. If a system were available which eliminated the need for agents to assign vehicles to customers and for other vehicle rental agency personnel to place vehicles in appropriate parking spots, self-service vehicle rental or sharing operations might be possible and the vehicle rental agencies might save substantial sums of money.

Therefore, there is a need in the industry for a system which, in accordance with prior reservations, assigns appropriate vehicles to customers and enables the customers to pickup the vehicles without human interaction, and which addresses related, and unrelated, difficulties and shortcomings.

### SUMMARY OF THE INVENTION

Briefly described, the present invention comprises a system, including apparatuses and methods, for managing vehicle reservations, vehicle assignment, and vehicle access. The system enables a rental vehicle or car sharing agency (i.e., or for that matter, a vehicle fleet management service or other entity or group which assigns vehicles to users thereof) to assign vehicles to users in accordance with previously received reservations, and enables the users to pickup the vehicles for their use, without interaction with agency or other personnel.

In one form of the invention, the system includes computer and telecommunications hardware and software which enable a user of the agency, or service, to interact with the system through a telephone. Upon receiving a telephone call from the user, the system identifies the user, perhaps, through inbound caller identification information and/or receipt of personal identification number (PIN) information from the user. Determining that the user has previously made a vehicle reservation, for example and not limitation, by prior interaction with an Internet-based or other reservation system and detecting that the reservation is to start soon (i.e., within a preset period of time), the system enables the user to immediately initiate the vehicle pickup process without having to traverse other system options. Then, the system assigns a vehicle to the user based upon criteria provided by the user when making the reservation, upon current vehicle parameters (for example, with respect to electric vehicles, the level of electrical charge on available vehicles' batteries), and/or upon other relevant criteria or parameters.

Once the system has assigned a vehicle to the user, the system communicates information to an intelligent interface on the assigned vehicle, thereby informing the interface that the vehicle has been assigned to a particular user and that it should unlock the vehicle's doors when the user appropriately identifies himself/herself to the vehicle (for example and not limitation, by presentation of a smart key or smart card, by input to a door lock keypad of the user's PIN information, or by use of other apparatuses and methods). The system also communicates to the user the number of the assigned vehicle (i.e., which is affixed to the vehicle by a tag or other method and visible to potential users) or the number of the parking spot in which the vehicle currently resides after having been parked there by a previous user, via the user's telephone, so that the user may identify the assigned vehicle from other vehicles which may be present in a vehicle parking/pickup area.

Upon receiving appropriate identification information from the user, the vehicle's intelligent interface unlocks the vehicle's doors and allows the user to enter the vehicle. The interface also communicates information back to the system informing the system that the user has been allowed entry into the vehicle. If the vehicle is an electric vehicle and is still connected to a charger, the vehicle's interface communicates information to the system informing the system that the user has not disconnected the vehicle from the charger. In response thereto, the system communicates a reminder to the vehicle's user reminding the user to disconnect the charger from the vehicle. Once the vehicle is ready to be placed into use, the vehicle's intelligent interface allows the user to start the vehicle and drive away at the user's discretion, while the system communicates information about the user's vehicle reservation to the user and enables the user to modify the reservation or access other features of the system.

When the user is ready to return the vehicle to the vehicle parking/pickup area, the user establishes communications with the system via telephone and drives the vehicle into a parking spot of the user's selection. The system, presuming that the user desires to return the vehicle, asks the user if the vehicle is being returned and receives confirmation of such from the user. Once the vehicle has come to a stop and, if the vehicle is an electric vehicle, has been connected to a charger near the parking spot, the vehicle's intelligent interface communicates information to the system informing the system that it has been returned to the vehicle parking/pickup area. The system instructs the user to check the vehicle for any personal items left in the vehicle and requests that the user inform it when the user is ready to end his/her use of the vehicle. Upon receipt of such information from the user (i.e., via telephone), the system communicates information to the vehicle's intelligent interface instructing the interface to lock the vehicle's doors and to not allow anyone to enter the vehicle (i.e., perhaps, other than a service technician) until instructed otherwise.

Advantageously, the present invention assigns vehicles to users absent interaction between the users and agency, fleet management, or service personnel and taking into account circumstances in existence at the time of vehicle pickup, thereby enabling optimal assignment of vehicles based upon those circumstances. By enabling vehicle assignment without such interaction and doing so in “real time,” the present invention may reduce costs to vehicle rental or car sharing agencies, fleet management services or other similar entities, and may avoid the reassignment of vehicles to users which often occurs when vehicles are pre-assigned to users without taking present circumstances into account. The present invention also enables users to pickup a vehicle through use of a wired or wireless telephone and without having to stand in line. In addition, the present invention enhances vehicle security (i.e., minimizing the potential of vehicle theft or vandalism) by enabling access to the interior of vehicles only to users with reservations (and, of course, to service technicians) and by controlling the time periods during which such access is permitted.

Various other features and advantages of the present invention will become apparent upon reading and understanding the present specification.

### BRIEF DESCRIPTION OF THE DRAWINGS

FIG. 1 displays a block diagram illustration of a vehicle assignment and pickup and environment therefor system according to a first embodiment of the present invention.

FIG. 2 displays a block diagram illustration of an intelligent vehicle monitoring and control system according to a first embodiment of the present invention.

FIG. 3 displays a block diagram representation of a program and data domain of the vehicle assignment and pickup system according to a first embodiment of the present invention.

FIGS. 4A and 4B display a flowchart representation of a method of a customer service application according to a first embodiment of the present invention.

FIGS. 5A, 5B, 5C, 5D, and 5E display a flowchart representation of a method of a vehicle assignment application and pickup according to a first embodiment of the present invention.

FIGS. 6A, 6B, 6C, 6D, and 6E display a flowchart representation of a method of a vehicle return application according to a first embodiment of the present invention.

### DETAILED DESCRIPTION OF THE PREFERRED EMBODIMENT

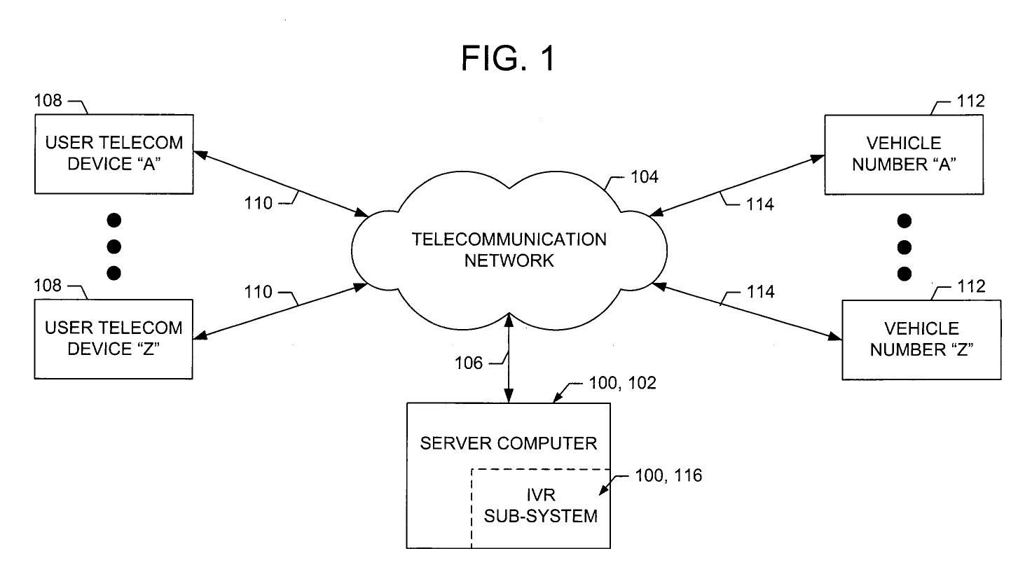

Referring now to the drawings, in which like numerals represent like components or steps throughout the several views, FIG. 1 displays a block diagram illustration of a system for enabling and facilitating the assignment and pickup of vehicles 100 (also sometimes referred to herein as the “system 100” or as a vehicle assignment and pickup system 100) to users thereof from a plurality of vehicles 112 which are generally managed as a vehicle fleet, and the environment therefor in accordance with a first embodiment of the present invention. The system 100, preferably, comprises a telecommunications-enabled, server computer 102 (also sometimes referred to herein as the “system server 102”) residing at a first site. The system server 102 is configured with hardware and software (described more particularly below) appropriate to perform the tasks and provide the capabilities and functionality described herein and operates, preferably, continuously during operation of the system 100 to provide vehicle assignment and pickup services on a twenty-four hour, seven day a week basis without human intervention. To provide such round-the-clock services, the system server 102 connects communicatively to a telecommunication network 104 through a communication link 106 for the bi-directional communication of voice and/or data, as is required and/or appropriate, with the telecommunication network 104 and with other devices communicatively linked to the system server 102 via the telecommunication network 104 as described below. It is understood that the scope of the present invention includes a system 100 having a plurality of server computers 102 or other functionally similar devices which reside, perhaps, at different sites, which are possibly communicatively connected to each other by a local area network (and/or a wide area network or other form of communication link), and which communicatively connect to the telecommunication network 104.

A plurality of user telecommunication devices 108 (i.e., designated on FIG. 1 and also sometimes referred to herein as “user telecom devices 108”), possessed and used by respective users of the system 100, are connectable for communication with the system server 102 through respective and appropriate communication links 110, telecommunication network 104, and communication link 106. As described below, users utilize their respective user telecom devices 108 to provide input and/or selections to the system 100 whereby, in response thereto, the system 100, for example and not limitation: analyzes (i) previously made reservation(s) for vehicles by a user attempting to pickup a vehicle for his/her use, (ii) previously made reservations by other users desiring vehicles for their use, (iii) user profile information, and (iv) vehicle information; identifies and selects a vehicle for use by each user in association with respective reservations; assigns vehicles to users for their use; and, enables access to and use of vehicles by users thereof.

The user telecom devices 108, preferably, include voice telecommunication devices which are connectable to the telecommunication network 104 for bi-directional communication of voice and/or DTMF signals with the server computer 102 (and, more specifically, with the hardware and software interfaces of its interactive-voice-response (IVR) sub-system 116). Preferably, the user telecom devices 108 include, without limitation, analog, digital, wired and wireless telephones or other similar devices which enable the bi-directional communication of voice and/or DTMF signals. Similarly, the communication links 110 include, preferably, analog, digital, wired and wireless communication channels which enable the bi-directional communication of voice and/or DTMF signals over, for example and as appropriate, copper, optical fiber, radio frequency, infrared, satellite or other media. It is understood that the scope of the present invention includes other forms of user telecom devices 108 and communication links 110 available now or in the future.

The plurality of vehicles 112 includes, but is not limited to, land-based craft (such as automobiles, trucks, buses, motorcycles, and other similar craft), aircraft, water craft, and other vehicles which may be used for transportation or recreation. The vehicles 112 may be powered by various propulsion systems, including without limitation: hydrocarbon-based engines (such as gasoline, diesel, or hydrogen); electric power systems comprising fuel cells, batteries, and electric motors; hybrid propulsion systems; and other propulsion systems which are available now or in the future.

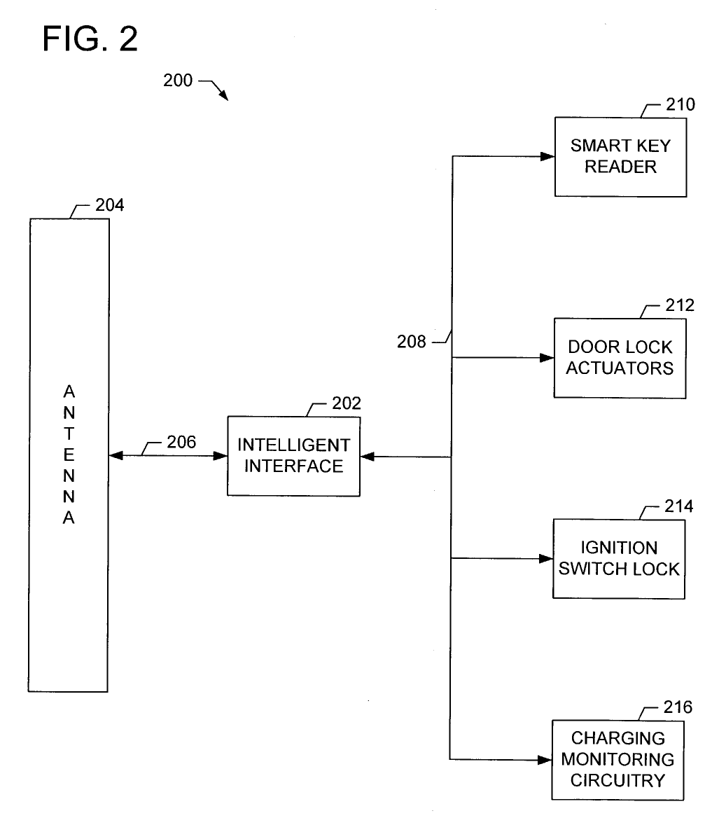

Notably, as illustrated in FIG. 2, each vehicle 112 includes an on-board, intelligent vehicle monitoring and control system 200 having an intelligent interface 202 with a processing unit, memory, and multiple communication interfaces therein. The processing unit is capable of receiving commands and performing various actions in response to the commands which may or may not require interfacing with other vehicle components as described herein. One such communication interface connects to an antenna 204 via communication link 206 for the wireless and bi-directional communication of command and/or data signals with the server computer 102 (and its appropriate communication interfaces) and/or with other similar computers via the telecommunication network 104 and communication links 106, 114. Preferably, communication link 114 is a wireless GPRS communication link using the 802.11(b) protocol, but other forms of wireless communication links are considered to be within the scope of the invention. Another such communication interface connects the processing unit to a bus 208 (i.e., preferably, a CAN bus) which bi-directionally communicates commands and/or data with devices connected to the bus 208 at various locations in a vehicle 112. Exemplary devices include a smart key reader 210, door lock actuators 212, an ignition switch lock 214, and charging monitoring circuitry 216 (i.e., for electric vehicles 112).

For vehicles 112 having doors which must be opened to gain entry or exit from the vehicles 112, the smart key reader 210 is mounted, preferably, in the driver's door near a location where a conventional door lock is found in most similar vehicles. The smart key reader 210 is capable of reading (i.e., when a smart key is positioned in close proximity to the smart key reader 210 by passive radio frequency) an identification code which is stored in a smart key having a housing with a memory (i.e., for storage of the identification code) therein and a toothed portion extending from the housing for receipt by a vehicle's ignition lock. The identification code represents a unique user code which is assigned to each user to whom a smart key is issued for use of the vehicles 112 in a fleet of vehicles 112. The toothed portion of the smart key is the same for each smart key. Thus, the toothed portion of each smart key is capable of being used in the ignition switch of any vehicle 112 of a fleet of vehicles 112 to cause operation of the vehicle 112. The smart key reader 210 is also capable of communicating an identification code which it reads from a user's smart key to the intelligent interface 202, via the bus 208, for comparison with an identification code downloaded to the intelligent interface 202 from the server computer 102 and stored in the memory of the intelligent interface 202 as described below.

The door lock actuators 212 are operable, in vehicles 112 having door locks, to disengage or engage door locks which, respectively, allow or do not allow opening of the vehicle's doors. The door lock actuators 212 are responsive to appropriate commands received, via the bus 208, from the intelligent interface 202. For example, when the intelligent interface 202 receives an identification code from the smart key reader 210 which matches the identification code stored in its memory (i.e., downloaded from the server computer 102) and communicates a command to open the vehicle's door locks, the door lock actuators 212 responsively operate to disengage the vehicle's door locks, thereby enabling ingress to or egress from (i.e., access to or from) the vehicle 112.

The ignition switch lock 214 is adapted to control whether a user may “turn-on” and use a vehicle 112 by inserting the toothed portion of the user's smart key into the vehicle's ignition switch and turning the smart key's toothed portion similar to that of a conventional vehicle ignition switch. The ignition switch lock 214 is responsive to appropriate commands received, via the bus 208, from the intelligent interface 202 and operates to allow or not allow the smart key to “turn-on” or “start” the vehicle 112 based upon the particular command(s) received. For example, in a vehicle 112 having an electric propulsion system, if the intelligent interface 202 determines that the identification code stored in a user's smart key matches the identification code stored in the memory of the intelligent interface 202 and communicates an appropriate command to the ignition switch lock 214 (i.e., allowing use of the vehicle's ignition switch to “start” the vehicle by electrically connecting the batteries and the vehicle's electric motors via a throttle), the user may begin use of the vehicle 112 by inserting the toothed portion of his/her smart key into the vehicle's ignition switch and turning the key. However, if the intelligent interface 202 determines that the identification code stored in a user's smart key does not match the identification code stored in the memory of the intelligent interface 202 and communicates an appropriate command to the ignition switch lock 214 (i.e., not allowing use of the vehicle's ignition switch to “start” the vehicle 112), the user may insert the toothed portion of his/her smart key into the vehicle's ignition switch and turn same, but the vehicle 112 will not “start” or be usable by the user.

In an electric vehicle 112, the charging monitoring circuitry 216 monitors whether or not the vehicle 112 is connected to charging equipment located, for instance, at a site where users pickup vehicles 112 for their use. The charging monitoring circuitry 216 also monitors the level of charge of the vehicle's on-board batteries. This connection and charge status information is communicated by the charging monitoring circuitry 216 to the intelligent interface 202 via the bus 208 in response to the receipt of an appropriate command(s) therefrom. The intelligent interface 202 communicates the received connection and status information to the server computer 102 via the telecommunication network 104 and communication links 106, 114. Such information is stored, as described below, by the server computer 102 or similar computer in a vehicle information database 318 which contains vehicle-related information for all vehicles 112 in a fleet of vehicles 112.

Referring back to FIG. 1, the telecommunication network 104 includes the wired and wireless facilities, infrastructure and processes appropriate to bi-directionally communicate voice and/or data, as required, between the various communicating devices described herein. The telecommunication network 104 comprises, but is not limited to, analog and digital wired voice and data networks, analog and digital wireless voice networks, and analog and digital wireless data networks (including, those using the 802.11(b) protocol such as GPRS). It should be understood that the scope of the present invention includes wired and wireless, voice and data communication networks which are available now or in the future.

The system server 102, preferably, comprises a bus, a central processing unit (CPU), a random access memory (RAM), and a storage device interface which, respectively, connect to the server's bus for bi-directional communication of signals and data with each other through the bus. A hard disk drive and a CD ROM drive communicatively connect to the storage device interface for the bi-directional communication of signals and data therebetween. It is understood that the scope of the present invention includes a system server 102 having a plurality of hard disk drives and/or other types of storage devices having appropriate capacity for the storage of operating system software, applications, and data.

The system server 102 also, preferably, includes a display interface and a display device. The display interface connects to the server's bus for bi-directional communication of signals and data therewith and communicatively connects to a display device for the uni-directional communication of signals and data to the display device. Also, the system server 102 includes an interactive voice response (IVR) sub-system 116 which enables the system 100 to generate prompts and/or instructions (i.e., under application program control as described below) which are communicated to a user's telecom device 108 via telecommunication network 104 and to receive and interpret users' inputs and/or selections in the form of voice responses or DTMF signals. Additionally, the system server 102, preferably, comprises an appropriate plurality of telecommunication network interfaces (i.e., also sometimes referred to herein as a “telecom network interfaces”) which connect to the telecommunication network 104 for bi-directional voice, signal and data communication with user telecom devices 108 and the intelligent interfaces 202 of vehicles 112. In addition, the system server 102, preferably, includes a printer interface, a keyboard interface, and a pointing device interface which connect for bi-directional signal and data communication with a printer, a keyboard, and a pointing device, respectively. Further, the system server 102, preferably, comprises a serial interface which is connectable to external serial devices, and a power supply which connects to an external source of alternating electrical current (AC). A system server 102, acceptable in accordance with the preferred embodiment, is an enterprise computer server manufactured by Compaq Corporation of Houston, Tex. having appropriate versions of the elements described herein. It is understood that the scope of the present invention includes other forms of system servers 102, available now or in the future or from other manufacturers.

In operation, the power supply provides direct electrical current (DC) at appropriate voltage levels to the server's bus, thereby enabling operation of the server computer 102. The CPU executes the methods and instructions of computer software programs or applications, described below, which reside on the hard disk drive and which temporarily reside in RAM for execution by the CPU. The CPU, operating under the control of the computer software applications, causes the system server 102 to communicate with user telecom devices 108 and vehicle intelligent interfaces 202 for the exchange of input and output data therewith, to perform the methods and tasks described herein, and to provide the system capabilities and functionality also described herein.

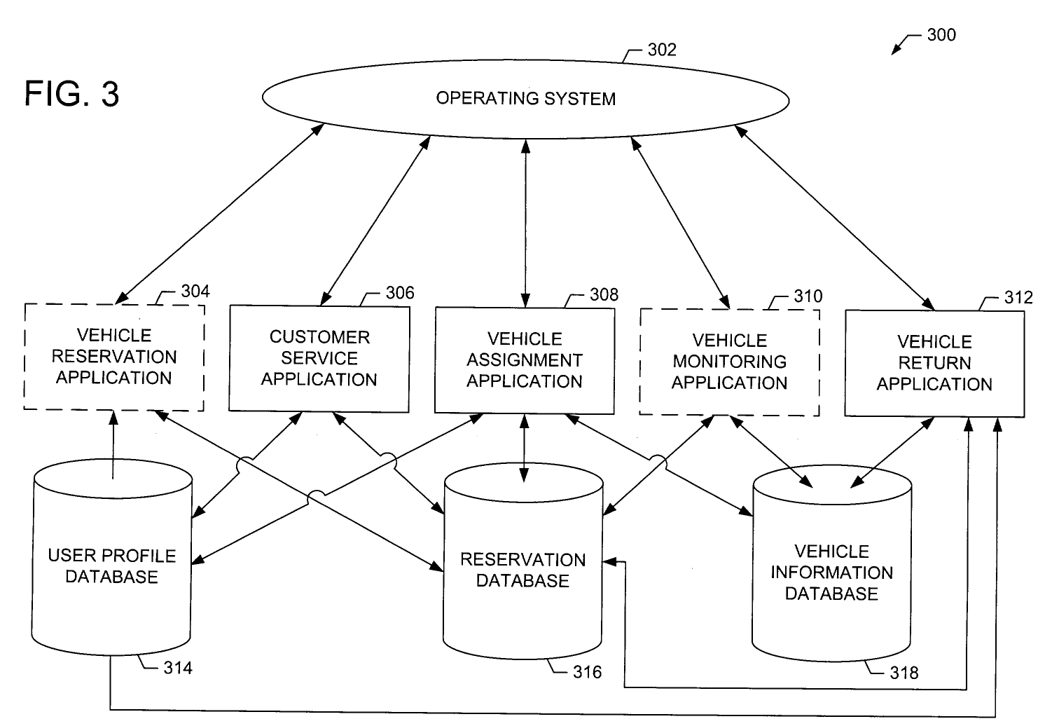

FIG. 3 illustrates a program and data domain 300 of the system 100 in accordance with the first embodiment of the present invention. The program and data domain 300 comprises a multi-tasking, virtual operating system 302, a plurality of applications (i.e., a customer service application 306, a vehicle assignment application 308, and a vehicle return application 312), a user profile database 314, a reservation database 316, and a vehicle information database 318 which, respectively, represent computer programming and data stored on the system server's hard disk drive(s). Note that the arrow heads in FIG. 3 indicate the direction in which data is communicated relative to the applications and databases. An operating system acceptable in accordance with the first embodiment includes the Microsoft NT Operating System which are available from Microsoft Corporation of Redmond, Wash. It is understood that the scope of the present invention includes other forms of operating systems, including operating systems based on a UNIX platform, available now or in the future from other manufacturers.

Note that FIG. 3 also displays a plurality of applications in dashed lines to indicate that such applications are not considered to be a part of the vehicle assignment and pickup system 100 of the present invention, but instead, provide the environment and context for the present invention. For example, the vehicle reservation application 304 resides on the system server 102 and is executed by the system server 102 in response to users indicating a desire to reserve a vehicle 112 for use by accessing an Internet web site enabling such reservation or by calling a vehicle reservation telephone number. The vehicle reservation application 304 collects information related to a reservation from each user, including, but not limited to: the user's identification code (i.e., assigned to a user when the user is provided with a smart key for use with a fleet's vehicles 112); the start day/time of the reservation; the end day/time of the reservation; the desired vehicle pickup location; the desired vehicle return location; and, if more than one type of vehicle 112 is available, the type of vehicle 112 desired by the user. The vehicle reservation application 304 also confirms, through access and comparison of user identification code information previously stored for the user in the user profile database 314 with the received user's identification code, whether the user is a valid system user and/or is allowed to make a vehicle reservation. Such reservation information, once collected, is stored by the vehicle reservation application 304 in the system's reservation database 316 for use by the system's applications as described herein.

Similarly, the vehicle monitoring application 310 resides on the system server 102 and is continuously executed by the system server 102 to monitor and collect vehicle information for a fleet's vehicles 112 through communication with the intelligent interface 202 of each vehicle 112 and communication of the vehicle's intelligent interface 202 with various devices, sensors, or sub-systems thereof. Such vehicle information includes, for example and not limitation: the battery charge level (i.e., for an electric vehicle); the fuel level (i.e., for a vehicle which consumes a fuel); door lock status (i.e., “locked” or “unlocked”); ignition switch status (i.e., “on” or “off”); location of the vehicle as determined by a global positioning satellite (GPS) system on-board the vehicle (i.e., and connected to or a part of the vehicle's intelligent interface 202); the tire pressures; the deployment state of air bags; and, the state of the vehicle's readiness for use by a user. As such information is received by the system server 102, the vehicle monitoring application 310 stores the information in the vehicle information database 318 for use by the system's applications as described herein.

It should be understood before proceeding further that prior to a user's pickup, use, and return of a vehicle 112, information related to the user is input into the user profile database 314 through use of a user setup application not shown in FIG. 3. The user setup application resides on the system server 102 and is executed by the system server 102 in response to users indicating their desire to begin using vehicles 112 of a fleet of vehicles 112 (i.e., “signing-up” with the system 100) by accessing an Internet web site or calling a setup telephone number and, in either case, providing certain user profile information. The user setup application collects information such as, for example and not limitation: the user's name; address(es); telephone number(s); email address(es); drivers license number; insurance carrier policy number(s); accident history; persons to contact in an emergency; vehicle preferences; credit card number(s) (i.e., for charging a fee for the use of a vehicle); and, other related information. The user setup application stores the information in the system's user profile database 314 after collection thereof. Additionally, the user setup application may optionally assign a unique user identification code, or key code, to the user and store the user's identification code, or key code, in the user profile database 314 in association with the user's other information. A smart key, programmed with the user's identification code, or key code, in its memory is subsequently provided to the user for use with the vehicles 112.

Continuing with respect to FIG. 3, the customer service application 306 enables a user, via voice prompts and voice and/or DTMF inputs, to access various system options including, but not limited to, the pickup of a vehicle 112 for use by the user. The customer service application 306 is executed by the system server 102 upon the system's receipt of a telephone call (i.e., from the user's wireless telecom device 108, from a wired user telecom device 108, or other user telecom device 108) from a user's telecom device 108 to a designated customer service telephone number via the telecommunication network 104. Once execution is initiated, the customer service application 306 attempts to identify the user based at least in part on automated number identification (ANI) information which is associated with the user's telecom device 108 received from the telecommunication network 104. If possible, the system 100 identifies the user using such information and allows the user to access the system 100. If not, the user is required to input identifying information such as, for example, the user's identification code and/or a personal identification number (PIN) selected by the user and stored previously in the user profile database 314. After determining the identity of the user, the customer service application 306 determines whether the user has a vehicle reservation that is about to begin and if so, immediately enables the user to pickup a vehicle 112. If no soon-to-begin reservation is found, the customer service application 306 enables the user access and use various other features of the system 100. Notably, in performing its tasks and providing such functionality, the customer service application 306 retrieves and/or searches user information from the user profile database 314 and from the reservation database 316 as described more particularly below.

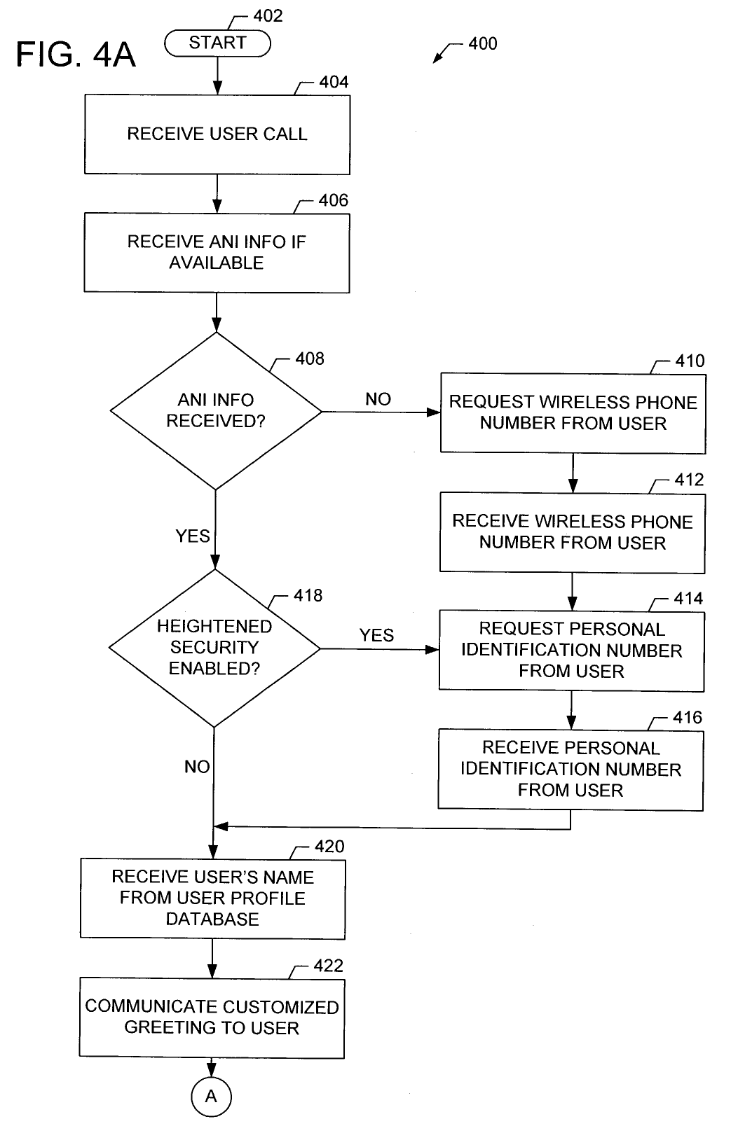

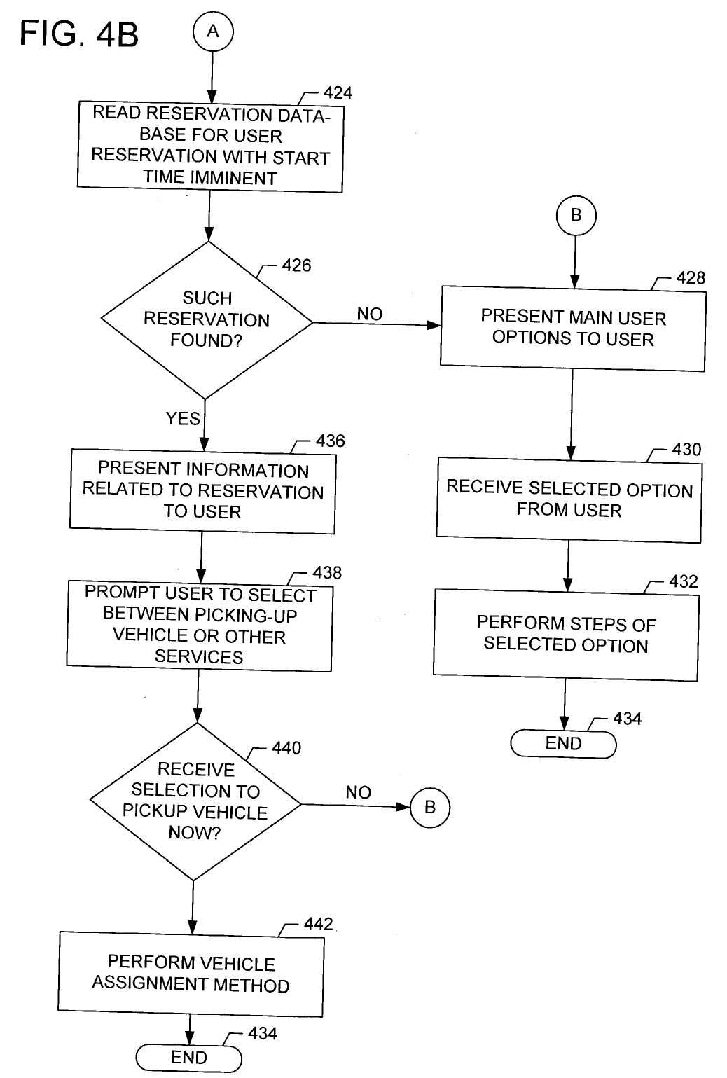

The vehicle assignment application 308 is executed by the system server 102 once it is determined that a user has a soon-to-being reservation and desires to pickup a vehicle 112 for use in connection with such reservation. The vehicle assignment application 308 interacts with the user through voice prompts and voice and/or DTMF inputs, respectively, generated and received by the system server's IVR sub-system 116. The vehicle assignment application 308 retrieves (or is passed) the user's identification code from the user profile database 314, retrieves information associated with the user's reservation from the reservation database 316, retrieves information associated with other reservations from the reservation database 316, and retrieves information from the vehicle information database 318. Using this information, the vehicle assignment application 308 analyzes the user's reservation in light of other reservations having the same vehicle pickup location and in light of the vehicle information associated with the various vehicles 112 at the pickup location which are potentially available for assignment to the user. For instance, the vehicle assignment application 308 may consider, for electric vehicles 112, the level of charge on the batteries of the available vehicles 112 and an estimate of the distance that the user may drive the vehicle 112 (i.e., based at least upon the start and end locations and start and end days/times for the user's reservation) to select or identify a vehicle 112 for use by the user. Then, the vehicle assignment application 308 downloads the user's identification code to the assigned vehicle's intelligent interface 202 and proceeds as more particularly described with respect to FIG. 4 below.

The vehicle return application 312 is executed by the system server 102 when the system 100 determines that the user desires to return a vehicle 112 to a particular site designated for the return of vehicles 112. Typically, the user indicates his/her desire to return the vehicle 112 by using the user's telecom device 108 to call a customer service telephone number associated with the system 100. Upon receipt of such a telephone call, the vehicle return application 312 provides the user with appropriate voice prompts and options to enable termination of the user's reservation and return of the vehicle 112. In doing so, the vehicle return application 312 accesses the user profile database 314 for user related information and updates the reservation database 316 and vehicle information database 318 to indicate the user's reservation has been terminated and the vehicle 112 resides at a particular return site and, if an electric vehicle 112, whether the vehicle 112 has been connected to external battery charging equipment.

FIGS. 4A and 4B display a flowchart representation of a method of the customer service application 306 in accordance with the preferred embodiment of the present invention. Starting at step 402 and then proceeding to step 404, the system 100 receives a call from a user telecom device 108. Preferably, the call is received from a wireless phone within 15 minutes of the starting time of the user's reservation while the user is near or at the location where he/she will pickup the vehicle 112.

When the call is received, the system 100 receives, if available, automatic number identification (ANI) information at step 406. At step 408, the system 100 determines if ANI information has been received. If ANI information has not been received, the system 100 requests that the user input his/her wireless telephone number at step 410. The user can input the information through the keypad of his/her wireless telephone (i.e., DTMF signals) or the user can simply say the digits of his/her wireless telephone number. At step 412, the system 100 receives the user's wireless number. The system 100 then requests the user to input his/her personal identification number (PIN), preferably through DTMF or IVR, at step 414, and at step 416, the system 100 receives the user's PIN.

Even if the system 100 receives a user's wireless phone number through ANI, the user may have chosen to have heightened security enabled during user setup. At step 418, the system 100 determines if the user has previously requested that heightened security be enabled. If so, then the system 100 at step 414 requests a PIN, and at step 416, the system 100 receives the PIN from the user.

After the system 100 receives the user's PIN if requested or after the system 100 receives the user's wireless number through ANI if heightened security is not selected, the system 100 at step 420 accesses the user profile database 314 and receives the user's name. The system 100 then communicates to the user a customized greeting, which includes the user's name, at step 422. An example of the greeting may be, “Good afternoon, Mr. Gordon.”

Advancing to step 424, the system 100 reads the reservation database 316 for a reservation for the user with a start time that is imminent, for example, within the next 15 minutes. The system 100 then determines if such reservation is found at step 426. If the reservation is not found, the system 100 proceeds to step 428 and presents several options to the user. One option may be to make a reservation for now or for later. In the next step, step 430, the system 100 receives a selected option from the user. If, for example, the user chooses to make a reservation for the next day, the system 100 proceeds to step 432 where the system 100 guides the user through the reservation process and ends at step 434. If, alternatively, the user chooses to make a reservation to pickup a vehicle 112 within 15 minutes, then the system 100 guides the user through the reservation process and loops back to step 426, where the system 100 determines that a reservation for this user does exist.

After the system 100 determines that this user's reservation exists, the system 100 then presents information related to the reservation to the user. The system 100 may present information such as the time and day a vehicle 112 has been requested, as well as which location to go to pickup the vehicle 112. For example, and not by way of limitation, the system 100 may communicate the following: “You have a reservation from 2:00 p.m. to 4:00 p.m. today at the Buckhead station.”

The system 100, at step 438, then prompts the user to select between picking-up the vehicle 112 now or other services. The system 100 then determines which option the user has selected at step 440. If the user chooses the other services option, the system 100 then presents the main user options to the user at step 428. Then at step 430, the system 100 receives the selected option from the user. The system 100 then performs the steps of the selected option at step 432 and ends the process at step 434.

If, however, the system 100 receives a selection that the user opts to pickup the vehicle 112 now, then the system 100 proceeds to step 442, where the system 100 performs the vehicle assignment method 500 at step 442 and ends the customer service method 400 at step 434.

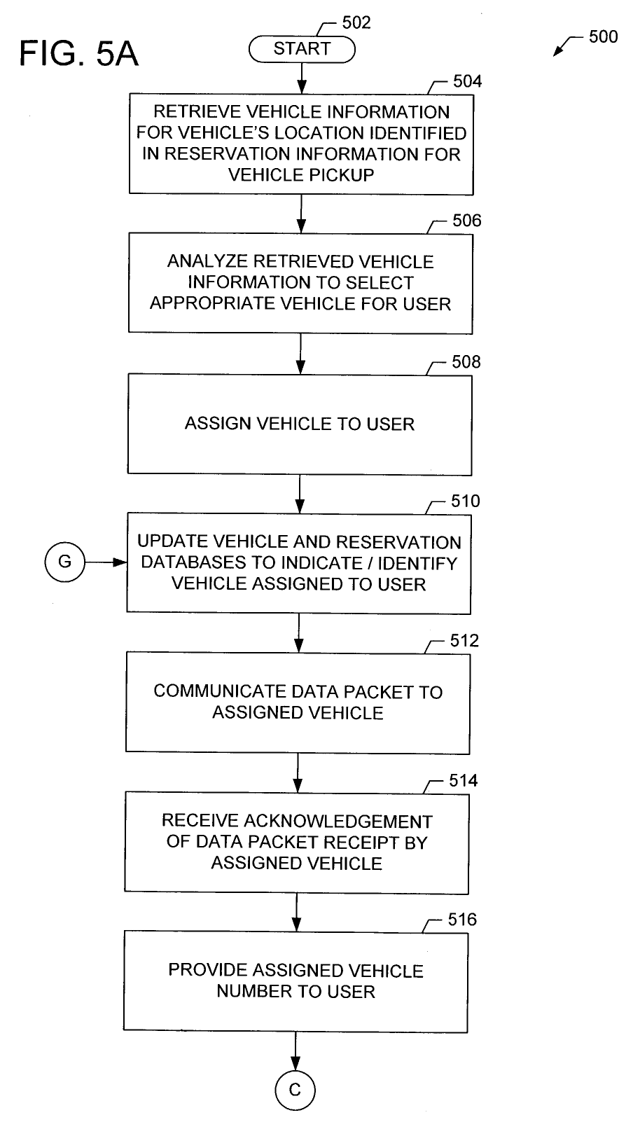

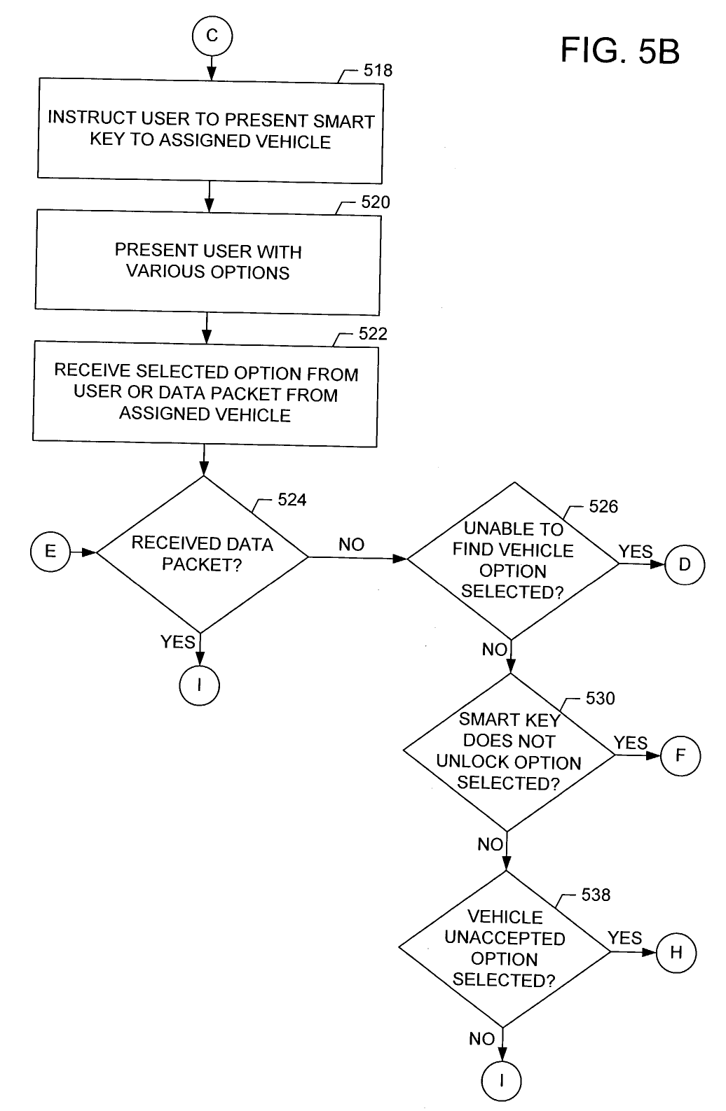

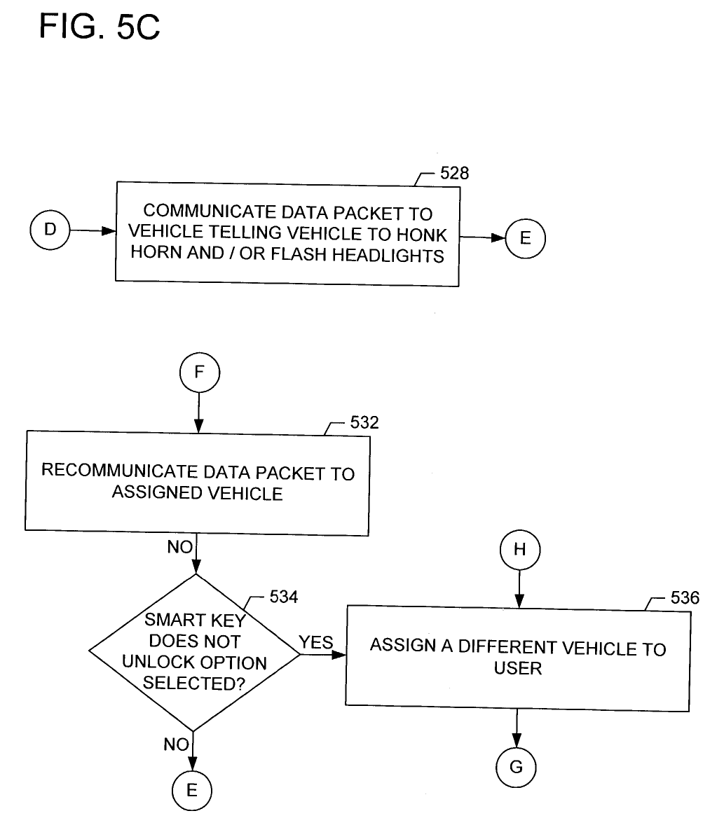

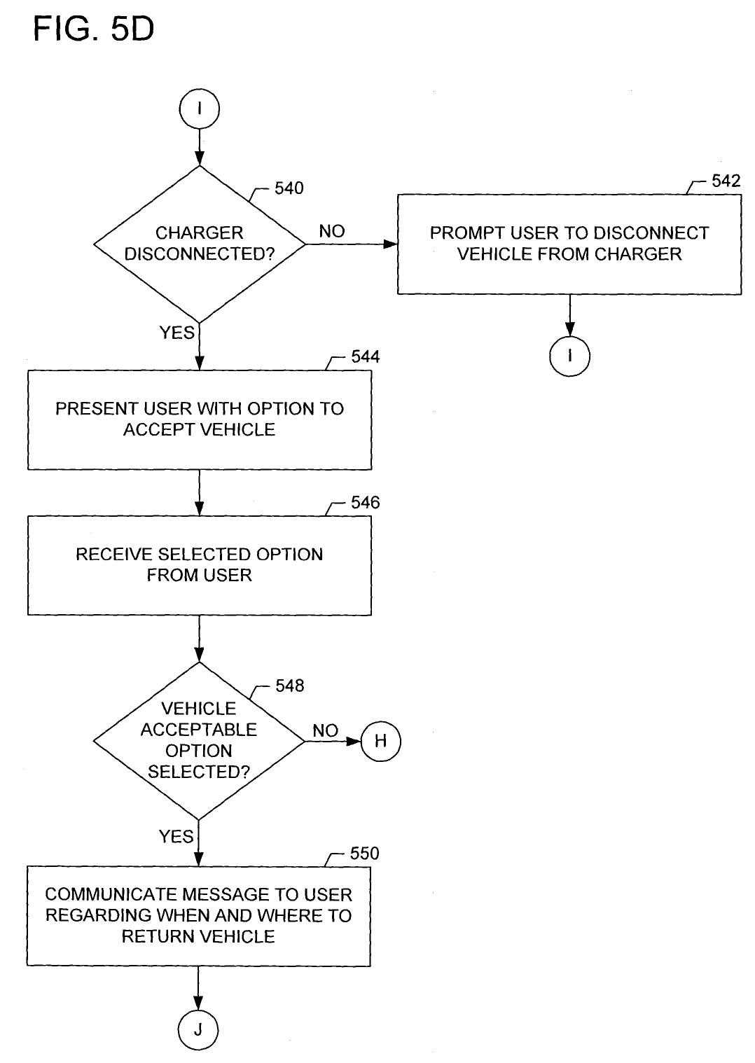

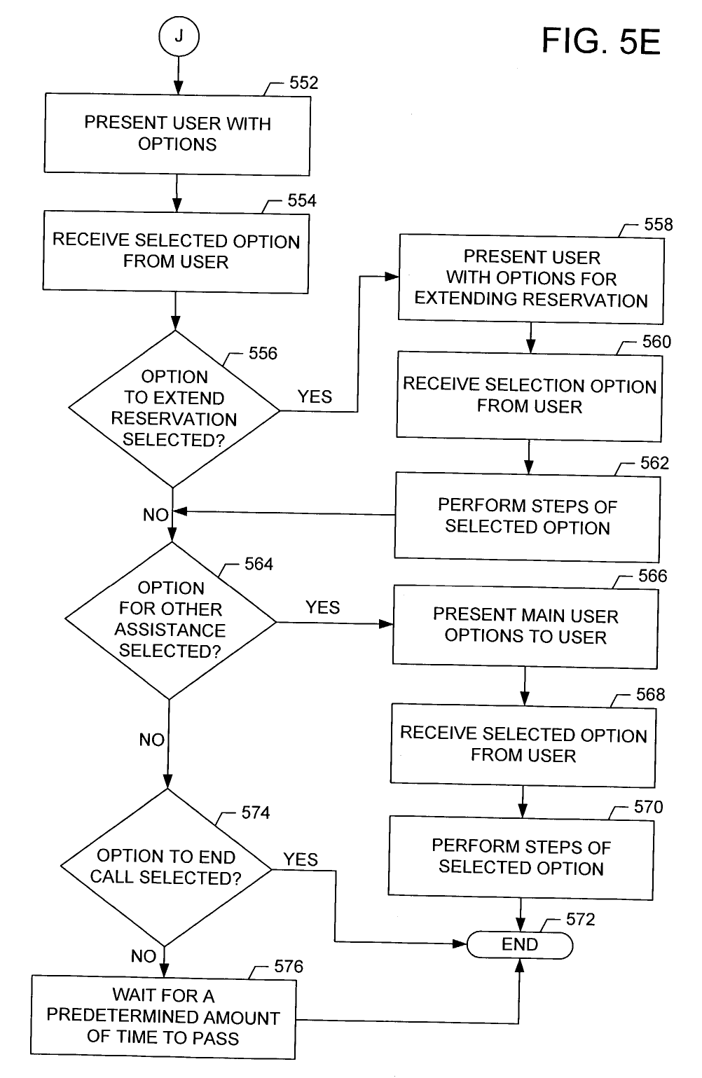

FIGS. 5A, 5B, 5C, 5D and 5E depict a flowchart representation of a vehicle assignment method according to the first embodiment of the present invention. The vehicle assignment method 500 begins at step 502 and proceeds to step 504, where the system 100 retrieves reservation and vehicle information for the vehicles located at the location identified in the reservation information. For example, the system 100 may access reservation information from the reservation database 316 such as the estimated mileage that the vehicle 112 will be traveling during the user's reserved time and may also access information such as the number of occupants each vehicle may have. The system 100 may also access the vehicle information database 318 for information such as the battery charge level of the vehicles 112 at the location where the user will be picking up a vehicle 112.

The system 100 then at step 506 analyzes the retrieved reservation and vehicle information to select an appropriate vehicle 112 for the user. The system 100 does this, for example, by comparing the available battery charge on a vehicle 112, which the system 100 uses to calculate how many miles the vehicle 112 may travel before its next charge, and the mileage the user anticipates traveling during the reserved time. The system 100 may also compare the number of occupants that will use the vehicle 112 with the types of vehicles available. For example, if only one person will use the vehicle 112, then the system 100 may select a compact vehicle, but if six people will use the vehicle 112, then the system 100 may select a mini-van.

Once the system 100 has selected an appropriate vehicle 112 for the user, the system 100 assigns the selected vehicle 112 to the user at step 508. Then, the system 100 updates the reservation database 316 and the vehicle information database 318 to indicate and to identify the vehicle 112 assigned to the user at step 510. The system 100 may also access the vehicle information database 318 and update its information to indicate a vehicle 112 is now reserved and is no longer idle at the location.

At step 512, the system server 102 communicates a data packet which uniquely identifies the user (e.g., personal identification code) to the assigned vehicle 112, which is received by the vehicle's intelligent interface 202. The vehicle's intelligent interface 202 receives and stores the information in its memory for subsequent use in locally authorizing or not authorizing the user's use of the assigned vehicle 112. Preferably, the system 100 communicates this data packet to the vehicle's intelligent interface 202 via General Packet Radio Service (GPRS). The intelligent interface 202 of the assigned vehicle 112 acknowledges the receipt of the data packet at step 514 by communicating a data packet via GPRS back to the system server 102.

At step 516, the system 100 provides the assigned vehicle number to the user. Alternatively, the system 100 may provide any other vehicle identifying information such as, but not limited to, the license plate number, the make, model and/or color of the assigned vehicle 112, or any other uniquely identifying characteristic. For example, and not by way of limitation, the system 100 may communicate the following message: “For this trip, you will be driving vehicle 105.” Preferably, the system 100 repeats the identifying characteristic of the assigned vehicle 112 so as to increase the likelihood that the user hears it correctly.

The system 100 then at step 518 instructs the user to present his/her smart key to the assigned vehicle 112. For example, the system 100 may communicate, “Please find vehicle 105 and present your smart key to vehicle 105.” After walking up to the assigned vehicle 112, the user waves the passive radio frequency device portion of his/her smart key past a smart key reader 210 of the assigned vehicle 112. The smart key reader 210 collects the user identification code or key number from the device and communicates it to the vehicle's intelligent interface 202. The intelligent interface 202 then compares the user identification code received from the smart key reader 210 to the user identification code received, as part of the downloaded reservation information, from the system 100. If both numbers match, the intelligent interface 202 causes the door lock actuators 212 to unlock the doors of the vehicle 112, thereby enabling the user to enter the assigned vehicle 112.

Next, the system 100 presents the user with various options at step 520. These options may include an option that the assigned vehicle 112 cannot be located, an option that the smart key does not unlock the assigned vehicle 112, and an option that the vehicle, for any reason, is unacceptable to the user. The system 100 then receives a selected option from the user or a data packet from the assigned vehicle 112 conveying to the system 100 that the assigned vehicle 112 has been successfully unlocked. At step 524, the system 100 determines whether a data packet has been received from the assigned vehicle 112. If not, the system 100 proceeds to step 526, where the system 100 determines if “the unable to find assigned vehicle option” has been selected. If this option has been selected, the system 100 at step 528 communicates a data packet to the assigned vehicle 112 telling the assigned vehicle 112 to honk its horn and/or flash its lights. The system 100 may, alternately or in addition to step 528, recommunicate the data packet to the originally assigned vehicle 112. The system 100 then loops back to step 524 to determine if a data packet has been received, and if it has whether the assigned vehicle 112 has been successfully unlocked, then the system 100 proceeds to step 540. If not, the system 100 goes to step 526. If “the unable to find the assigned vehicle option” has not been selected, then the system 100 determines if “the smart key does not unlock the assigned vehicle option” has been selected at step 530. If this option has been selected, the system 100 recommunicates the data packet to the assigned vehicle 112 at step 532. Then the system 100 prompts the user to input whether the vehicle doors are now unlocked and then determines which option from the user has been selected at step 534. If the smart key still does unlock the assigned vehicle 112, then the system 100 may assign a different vehicle 112 to the user. If the system 100 assigns a different vehicle 112, then the system 100 loops back to step 510 and repeats the method starting at step 510.

But if, however, “the smart key does not unlock the vehicle option” is not selected, the system 100 reverts back to step 524 to determine if a data packet has been received from the assigned vehicle 112. If not, then the system 100 repeats steps 524 through 530.

At step 538, the system 100 determines if “the vehicle is unacceptable option” is selected. If this option is selected, then the system 100 proceeds to step 536 and assigns a different vehicle 112 as described above.

If “the vehicle is unacceptable option” is not selected, then the system 100 advances to step 540, where the system 100 determines if the battery charger has been disconnected from the assigned vehicle 112. This may be accomplished by placing a switch at or near the location on the vehicle 112 where charging monitoring circuitry 216 is connected. When the battery charger is connected to the charging monitoring circuitry 216 of the assigned vehicle 112, the switch is depressed; however, when the battery charger is disconnected from the charging monitoring circuitry 216 of the assigned vehicle 112, the switch is not depressed.

If the charger is not disconnected, the system 100 at step 542 prompts the user to disconnect the assigned vehicle 112 from the battery charger. The system then goes back to step 540 to determine if the battery charger has been disconnected. If so, the system 100 then proceeds to step 544, where the system 100 presents the user with an option to accept the assigned vehicle 112. At step 546, the system 100 receives the selected option from the user. At step 548, the system determines whether “the vehicle is acceptable option” is received. If “the vehicle is acceptable option” is not selected, the system 100 goes back to step 536 and assigns a different vehicle to the user, as described above.

If “the vehicle is acceptable option” is selected, then the system 100 proceeds to step 550 and communicates a message to the user regarding when and where to return the assigned vehicle 112. An example of such message may be, “Please return your vehicle to the Buckhead station by 4:00 p.m.”

The system 100 then presents the user with options at step 552 and receives a selected option at step 554. These options may include an option for extending the user's reservation, an option for other assistance, and an option to end the call. At step 556, the system 100 determines whether the option to extend the user's reservation has been selected. If the option to extend the user's reservation is selected, the system 100 presents the user with options for extending the reservation at step 558. The system 100 then receives the selected option from the user at step 560 and performs the steps of the selected option at step 562.

If the option to extend the user's reservation is not selected, then the option for other assistance, such as, for example, to return the assigned vehicle 112 to a different location than originally requested, may be selected. At step 564, the system 100 determines if the option for other assistance has been selected. If so, then the system 100 proceeds to step 566, and presents the main user options to the user. The system 100 receives the selected option from the user at step 568, performs the steps of the selected option at step 570, and ends the vehicle assignment method 500 at step 572.

If, however, the option for other assistance has not been selected, then the system 100 determines at step 574 whether the option to end the call has been selected. If so, then the vehicle assignment method 500 ends at step 572. If not, then the system 100 waits for a predetermined amount of time to pass, for example two minutes, and then ends the vehicle assignment method 500 at step 572.

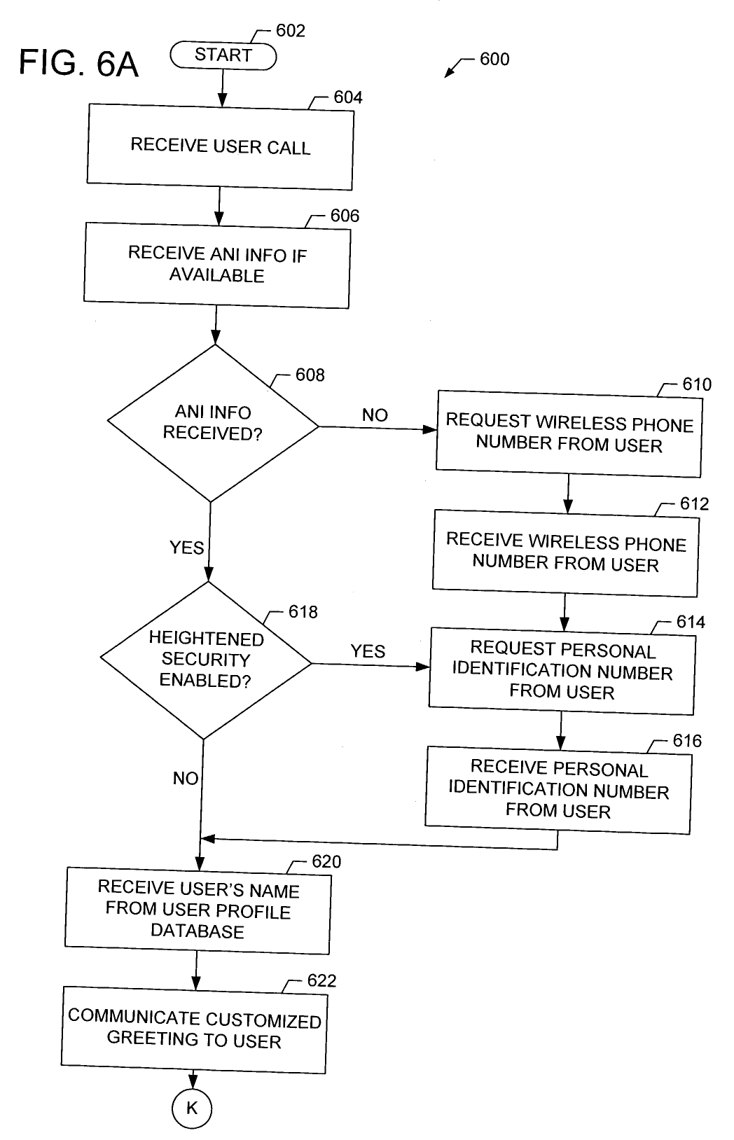

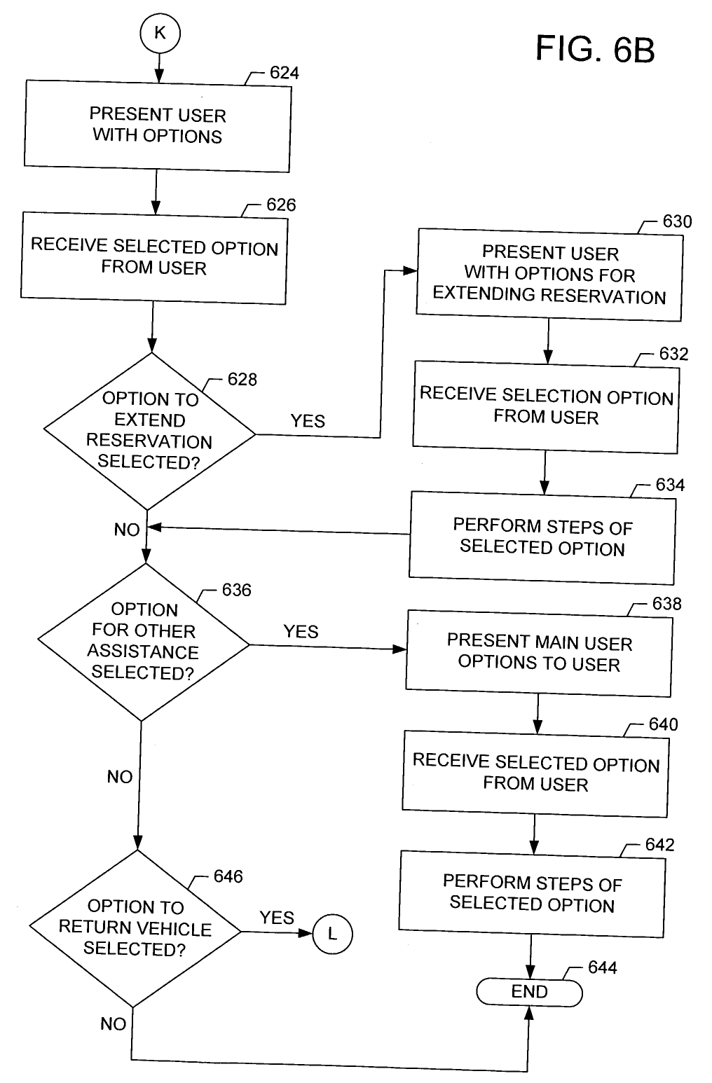

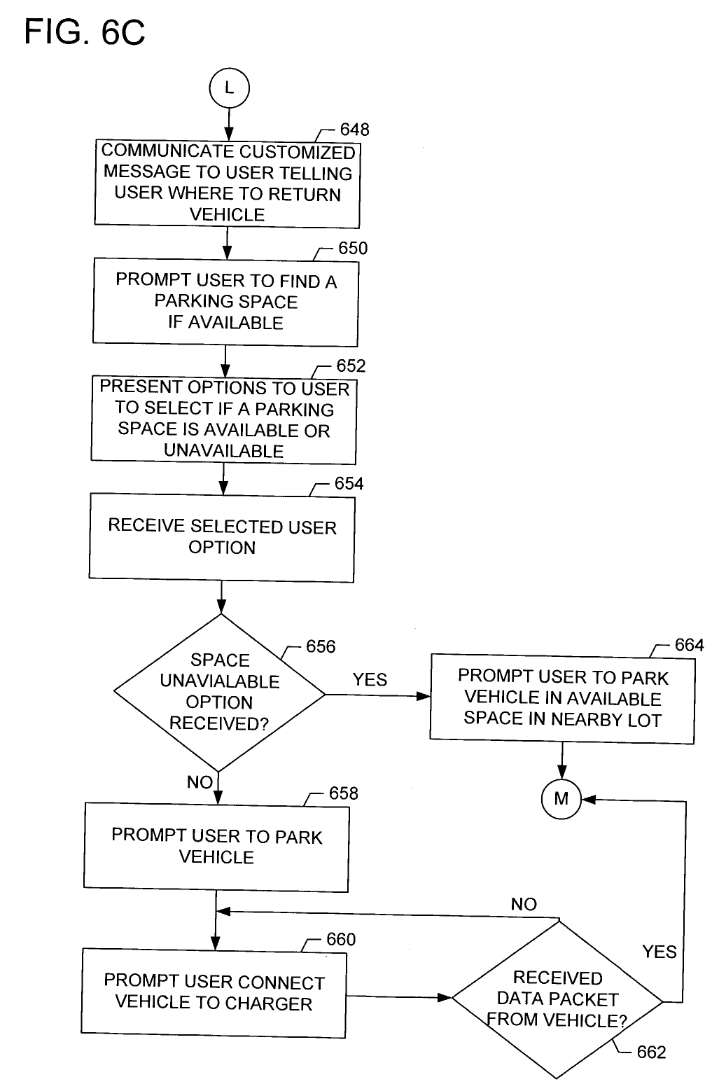

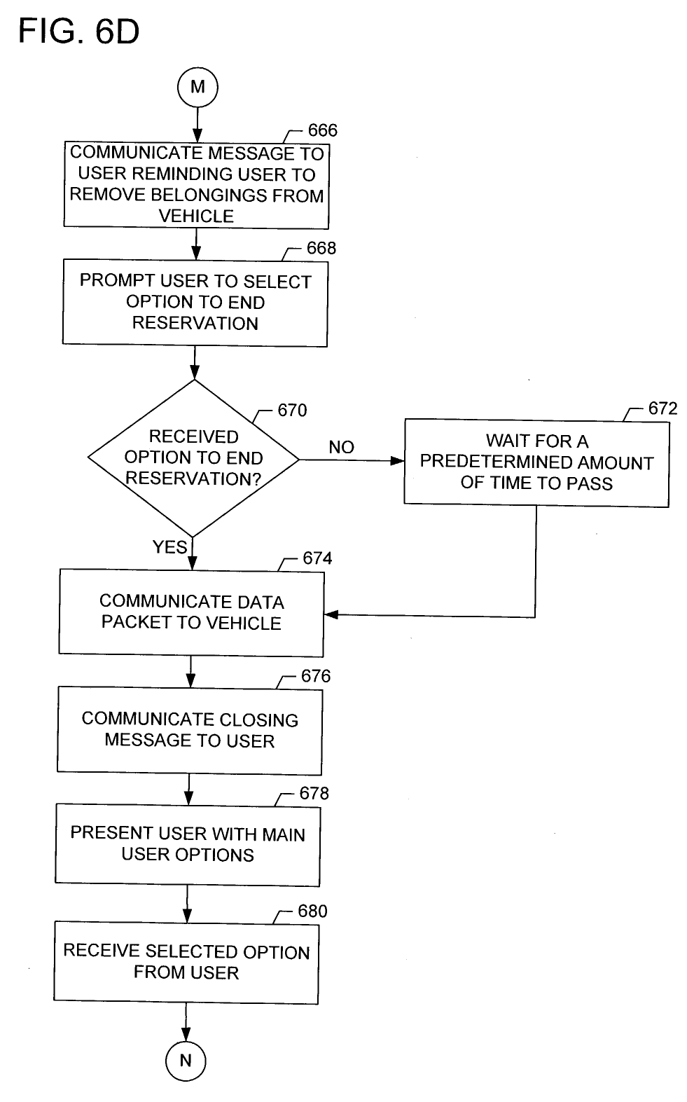

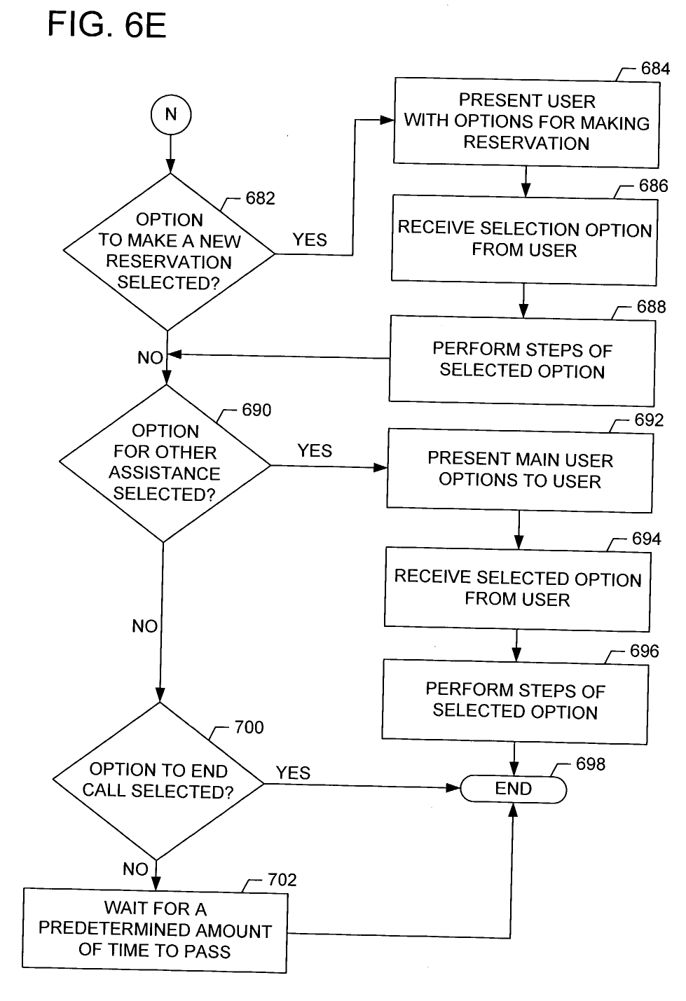

FIGS. 6A, 6B, 6C, 6D and 6E show a flowchart representation of a method of a vehicle return application 600 in accordance with the first embodiment of the present invention. Beginning at step 602 and proceeding to step 604, the system 100 receives a call from the user telecom device 108. Preferably, the call is received from a wireless phone as the user is returning the assigned vehicle 112 to the drop-off location.

When the call is received, the system 100 receives ANI information if available at step 606. At step 608, the system 100 determines if ANI information is received. If ANI information is not received, the system 100 requests that the user input his/her wireless telephone number at step 610. The user can input the information through DTMF signals, or the user can simply say the digits of his/her wireless telephone number. At step 612, the system 100 receives the user's wireless number. The system 100 then requests the user to input his/her PIN at step 614, and at step 616, the system 100 receives the user's PIN.

Even if the system 100 receives a user's wireless phone number through ANI, the user may have chosen to have heightened security enabled. At step 618, the system 100 determines if the user has previously requested that heightened security be enabled. If so, then the system 100 at step 614 requests a PIN, and at step 616, the system 100 receives the PIN from the user.

After the system 100 receives the user's PIN if requested by the system 100 or after the system 100 receives the user's wireless number through ANI if heightened security was not selected, the system 100 at step 620 accesses the user profile database 314 and retrieves the user's name. The system 100 then communicates to the user a customized greeting, which includes the user's name, at step 622. An example of the greeting may be, “Good afternoon, Mr. Gordon.”

The system 100 then proceeds to step 624, where the system 100 presents the user with options, and at step 626 the system 100 receives the selected option from the user. These options may include an option for returning the assigned vehicle 112, an option for extending the user's reservation, and an option for other assistance. At step 628, the system 100 determines whether the option to extend the user's reservation has been selected. If the option to extend the user's reservation is selected, the system 100 presents the user with options for extending the reservation at step 630. The system 100 then receives the selected option from the user at step 632 and performs the steps of the selected option at step 634.

If the option to extend the user's reservation is not selected, then the option for other assistance, such as, for example, to return the assigned vehicle 112 to a different location than originally requested, may have been selected. At step 636, the system 100 determines if the option for other assistance has been selected. If so, then the system 100 proceeds to step 638, and presents main user options to the user. At step 640, the system receives the selected option from the user, performs the steps of the selected option at step 642, and ends the method of the vehicle return application 600 at step 644.

If, however, the option for other assistance is not selected, then the option to return the assigned vehicle 112 may be selected. The system determines if the option to return the vehicle is selected at step 646. If this option is not selected, and if no options are selected, the system 100 will preferably time-out and disconnect the call, thereby ending the method of vehicle return application 600 at step 644.

But if the system 100 determines that the option to return the assigned vehicle 112 has been selected, then the system 100 proceeds to step 648. At step 648, the system 100 communicates a customized message to the user telling the user where to return the assigned vehicle 112. For example, and not by way of limitation, the system 100 may communicate the following message: “Please return the vehicle to the Buckhead station and connect it to the charger.”

The system 100 then proceeds to step 650 and prompts the user to park the assigned vehicle 112 in a parking space, if available. The system 100 at step 652 presents the user with two options: an option that a parking space is available and an option that a parking space is not available. At step 656, the system 100 determines if “the parking space is not available option” is selected. If not, the system 100 proceeds to step 658 and prompts the user to park the assigned vehicle 112 and, at step 660, to connect the assigned vehicle 112 to the battery charger. The system 100 then determines if it received a data packet from the intelligent interface 202 at step 662. In a preferred embodiment, the intelligent interface 202 communicates a data packet after the charging monitoring circuitry 216 of the assigned vehicle 112 has been connected to the battery charger. If a data packet has not been received by the system 100, then the system 100 loops back to step 660 and prompts the user to connect the assigned vehicle 112 to the battery charger.

However, if the system 100 determines at step 656 that the “parking space is not available option” has been selected, then the system 100 goes to step 664 and prompts the user to park the assigned vehicle 112 in an available space in a nearby parking lot. In another embodiment, the system 100 may prompt the user to drive to another location where the assigned vehicle 112 can be connected to a battery charger.

Advancing to step 666, the system 100 communicates a message to the user reminding the user to remove his/her personal belongings from the assigned vehicle 112. The system then at step 668 prompts the user to end the reservation. Once the reservation has ended, the user can no longer use his/her smart key to open the assigned vehicle 112 without making another reservation for vehicle 112. If at step 670, the system 100 has not received an option to end the reservation, preferably by entry of DTMF or voice response, the system 100 waits for a predetermined amount of time to pass, for example two minutes, and then proceeds to step 674, where the system 100 would have proceeded if the system 100 received an option to end the reservation at step 670.

At this step 674, the system 100 communicates a data packet to the intelligent interface 202 of the assigned vehicle 112 informing the assigned vehicle 112 that the user's smart key is to no longer open the doors of the assigned vehicle 112 until the intelligent interface 202 communicates a data packet telling it otherwise.

The system 100 then communicates a closing message to the user at step 676. An example of such closing message can be, “Thank you for using our vehicle.”

The system 100 then presents the user with options at step 678 and receives the selected option at step 680. These options may include an option for reserving a vehicle 112 for a future use, an option for other assistance, and an option to end the call. At step 682, the system 100 determines whether the option to reserve a vehicle 112 for future use has been selected. If the option to reserve a vehicle 112 for future use is selected, the system 100 presents the user with options for making a new reservation at step 684. The system 100 then receives the selected option from the user at step 686 and performs the steps of the selected option at step 688.

The system 100 then proceeds to present the user with option for other assistance, and at step 690, the system 100 determines if the option for other assistance has been received. If so, then the system 100 proceeds to step 692, and presents the main user options to the user. The system 100 receives the selected option from the user at step 694, performs the steps of the selected option at step 696, and ends the method of the vehicle return application 600 at step 698.

If, however, the option for other assistance has not been selected, then the system 100 determines at step 800 whether the option to end the call has been selected. If so, then the method of the vehicle return application 600 ends at step 698. If not, then at step 802, the system 100 waits for a predetermined amount of time to pass, for example two minutes, and then ends the method of the vehicle return 700 at step 802.

Whereas this invention has been described in detail with particular reference to its most preferred embodiment, it is understood that variations and modifications can be effected within the spirit and scope of the invention, as described herein before and as defined in the appended claims. The corresponding structures, materials, acts, and equivalents of all means or step plus function elements, if any, in the claims below are intended to include any structure, material, or acts for performing the functions in combination with other claimed elements as specifically claimed.

What is claimed is:

1. An apparatus as described herein, including each and every limitation and embodiment.

2. A method of operation as described herein, including each and every limitation and embodiment.
